(19) United States
(12) Patent Application Publication
(10) Pub. No.: US 2005/0037159 A1
(43) Pub. Date: Feb. 17, 2005

(54) High-resolution high-density positive image producing film using an ink jet printing machine and a method of making such a film

(76) Inventors: Manelal Chirayil Jacob Kurian, Mumbai (IN); Jivan Gulabraj Bhatt, Mumbai (IN)

Correspondence Address: MUSERLIAN, LUCAS AND MERCANTI, LLP, 475 PARK AVENUE SOUTH, 15TH FLOOR, NEW YORK, NY, 10016, US

(21) Appl. No.: 10/916,697

(22) Filed: Aug. 12, 2004

(30) Foreign Application Priority Data
Aug. 14, 2003 (IN) 808/MUM/2003

(51) Int. Cl. B41M 5/00

(52) U.S. Cl. 428/32.34

(57) ABSTRACT

This invention relates to a novel process of making of a positive image producing film by using an ink jet printer commercially available in the market and using a clear film coated with an ink receiving layer as described in this invention. It further describes the method of producing such a clear film for the purpose of using it as a positive for making printing masters for various printing applications.

### FIELD OF INVENTION

The invention relates to a high-resolution high-density positive image producing film using an ink jet printing machine and a method of making such a film.

### BACKGROUND

In any form of conventional image transfer by printing such as lithography, screen printing, flexo printing on paper or in manufacturing printed circuit boards in electronic circuit making, a transparent image forming film is used as a ‘positive’. In the prior art, positives are typically created by the photographic method using a polyester or a cellulose derivative clear film coated with a silver halide emulsion or a diazo emulsion. Positives were made with these films using a variety of methods such as photographic image formation, and using equipment such as a photo type setting machine, a graphic art camera, a laser image setter and the like. These equipment are expensive. Moreover, many of the prior art methods also require further processing of the recorded film including developing, fixing and drying and these post processing requires the use of technicians skilled in the art. Still further, the entire process is also time consuming.

Yet again, processes such as high resolution Laser printing is sometimes used as an alternate option. However, laser printing is limited to certain applications as the printers are available only to limited sizes. Again color laser printers are currently very expensive.

Methods such as ink jet and laser printing are dry process and do not require such skilled operator or costly equipment.

Digital printing processes using ink jet printing technology are known for quite some time. Advances in printer head technology has now made direct printing on an ink jet printable medium, possible. Ink jet printing machines are available in sizes over what is required by most of the offset printing machines. Although they suffer from low speed as compared to that of photographic imaging systems, their significant advantage lies in the fact that they are very cost effective not only because of cheaper initial costs but also considerably lower costs in use.

The available technology of drop on demand (DOD) either use thermal or a piezo technology and is well known in industry for technical use as well as for home printing use. Also, the ink dot sizes have been considerably reduced over the years to an extent that ink jet printing technology can now deliver images far superior to offset printing with wider colour gamuts. This is also largely due to the fact that advances in ink jetting technology have made the ink droplet size so small that the image is light in areas of highlight and even in mid tones of a picture. However, such a condition is not good for a reproduction of images. Also, the software related to printer drivers has undergone tremendous advancement and there are many suppliers offering software, which can control drop sizes, dot sizes as well as drop distribution.

These advances have made ink jet imaging a versatile method of image creation.

However it has hitherto not been possible to produce a positive image on to a clear film which is further used for making a master plate for offset printing, a flexible plate for flexo printing, imaging on to a gravure cylinder, creating a silk screen stencil, creating a secondary master on Diazo films for all these above applications.

A major constraint that remained was the low UV and optical density of the dye based images, which make further process difficult or give poor quality images. Many ink jet printing system had the constraint of low UV density because the inks used were of low concentration and were transparent to UV light. In recent years major manufacturers of ink jet printers have introduced high density inks which make use of high dye concentration and image stability against light. Such inks give better UV light stopping power which is required to produce a film positive for the above mentioned applications.

Though ink jet printable clear films are available for transparency/over head projectors there hitherto it has not been possible to provide a clear ink receptive film for image transfer for making positives.

Though the hardware and software had developed, the ink receiving media is available for overhead projection systems only. These do not offer high resolution as the product require a very high resolution or high density. These commercially available films when used for creation of positive, suffered loss of image details on thicker lines, line exceeding a size of 24 points as well as block area where a large quantity of ink is to be thrown on to the media. In these areas ink “mottling” takes place.

Some workers have attempted to use special ink for this purpose. The ink incompatibility and corresponding withdrawal of guarantee by printer manufacturers made it difficult, to use of such technologies for commercial application.

Another problem observed in the commercially available films is that the ink density is not continuous so that the image formed is not uniform and such images cannot be transferred on to any further photomechanical printing masters effectively to give a good quality printing.

Various patents teach methods to prepare ink receptive coatings for use as transparency mainly for projections in presentations as well as for engineering images.

In German patent DE 2,234,823, an ink-receiving layer comprising gelatin and verity of particulate matter and colour molecules is described. U.S. Pat. No. 3,889,270 [no known Indian equivalent]describes an ink receiving layer comprising a molecular or colloidal disperse phase that enable the jetting ink to penetrate a few microns in to this layer. The binder (gelatin, albumin, casein, proteins, polysaccharides, cellulose and its derivatives or (copolymers of) polyvinyl alcohol is combined with hydrophilic silica and a white toner to prepare such films.

U.S. Pat. No. 4,503,111 describes an ink receiving media where a first binder (gelatin or polyvinyl alcohol (PVA) is mixed with polyvinyl pyrrolidone (PVP) having a molecular weight of at least 90,000 and for which the ratio PVA/PVP is in the range of 3:1 to 1:3.

This mixture of PVA, PVP or copolymers can also be combined with a coalesced latex of co-PVA-poly vinyl benzyl ammonium chloride as described in U.S. Pat. No. 4,547,405 [no known Indian equivalent] yielding a further improvement in water fastness.

Improvements in ink drying times can be achieved by particulate matter in the binder. Many patent applications have described this effect for many different binder systems. For example, U.S. Pat. No. 3,357,846 describes pigments such as kaolin, talc, barite, TiO₂. U.S. Pat. No. 3,389,270 describes use of silica in Gelatin, PVA and Cellulose.

Pigments and particles have also been descried in patent applications DE 2,295,769; GB 2,050,866; U.S. Pat. No. 4,474,850; U.S. Pat. No. 4,457,405, U.S. Pat. No. 4,578,285; WO 8806532; U.S. Pat. No. 4,849,286; EP 400,681; EP 411,638; EP 339,604; EP 411,638 and U.S. Pat. No. 5,045,864.

Unfortunately the films prepared by the various teachings described above fail to have the required image density and image sharpness to use as a positive for imaging on to a light sensitive system.

### OBJECTS OF THE INVENTION

The principal object of this invention is to make a high resolution high density film using a standard ink jet printer without the use of special inks.

A further object of this invention is to produce a positive film in a dry process, economically and relatively quickly.

Yet another object of this invention is to produce a positive film which is dimensionally stable and is adapted to reproduce technically usable images for a multitude of printing applications.

In accordance with another aspect of the invention, there is provided a process for making a positive film, such a process being of great commercial importance particularly because the investment on the imaging devices is most economical as compared to photographic film processing units.

More importantly the technology invented in accordance with this invention will allow cheaper production of image positives for further production of printing masters.

### DETAILED DESCRIPTION

According to this invention therefore there is provided a high-resolution high-density positive image producing film using an ink jet printing machine which comprises:
(a) a substrate of at least one layer of an optically clear hydrophobic polymeric resin having dimensional stability defined by two surfaces, said substrate being of thickness ranging from 50 to 200 microns, and defined by an operative image receiving surface; and a second inoperative backing surface;
(b) an ink-receptive coating layer provided on the said base coat said ink receptive coating layer of thickness ranging from 5 to 30 microns and having a dry weight between 5 g per sq. meter to 30 g per sq. meter and being formed by coating with a liquid coating emulsion comprising, as a uniform blend in an aqueous medium:
[i] water soluble hydrophilic polymer of medium molecular weight, mass of said water soluble hydrophilic polymer in the coating composition ranging from 5 to 20% of the total mass of the composition;
[ii] a cationic resin; mass of said cationic resin in the coating composition ranging from 3 to 8% of the total mass of the composition;
[iii] at least one binder; mass of said binder in the coating composition ranging from 2 to 10% of the total mass of the composition;
[iv] de-mineralized water, mass of said de-mineralized water mass in the coating composition ranging from 70 to 90% of the total mass of the composition;
(c) a bonding substratum coating of thickness ranging from 0.5 to 3 microns comprising a cross linkable water based polymeric resin provided between the ink-receptive coating layer and the substrate; and
(d) an anti static layer of thickness ranging from 3 to 8 microns provided on the inoperative surface of the substrate, said anti static layer comprising a solution of an anti static agent 0.01 to 1 percent, and a binder 10 to 20 percent dispersed in water.

The resin used for making the substrate may be at least one resin selected from a group containing polyethylene terephthalate, poly propylene, polycarbonate, cellulose diacetate, cellulose triacetate, clear resins of other of cellulose derivatives such cellulose acetate butyrate, or cellulose acetyl phthalate, polyvinyledene fluoride, clear acrylic, nylon and its derivatives, and polyvinyl butyral or mixtures thereof.

The substrate may be in the form of a single layer or may be multi layered, each layer having a single resin or a mixture of at least two resins.

The substrate may be made anti-static.

At least one of the surfaces of the substrate may be subjected to treatment to enhance the adhesion of water based coatings on the surface.

Such surface treatment may include corona treatment or etching with an acid or alkali or flame treatment, plasma treatment, or ion etching.

The coating of the ink receptive film is water based emulsion. These water-based emulsions are not compatible with the hydrophobic films as used in this invention. These films are therefore treated by a plurality of methods such as corona treatment, or coating a hydrophilic polymer layer over the film there by making the film receptive to water based emulsions and also provide very good adhesion of the dried layer, the method of these treatments are known to the people in the art.

The water soluble hydrophilic polymer in the emulsion of the ink receptive layer is a polymer selected from a group of polymers containing polyvinyl alcohol, derivatives of polyvinyl alcohol such as acetoacetylated polyvinyl alcohol, borated polyvinyl alcohol, cationised polyvinyl alcohol, or a combination of these, poly acryl amide, acrylic acid co polymers, and polyamines.

The hydrophilic polymer, typically the polyvinyl alcohol used can be partially hydrolyzed or fully hydrolyzed.

In accordance with a preferred embodiment of this invention the emulsion of the ink receptive layer includes an acrylic or vinyl polymer, mass of said acrylic polymer in the coating composition ranging from 2 to 10% of the total mass of the composition.

In accordance with a preferred embodiment of this invention the emulsion of the ink receptive layer includes at least one surface modifying agent up to 0.01 percent of the total mass of the emulsion.

Typically, at least one surface modifying agent is selected from a group of surface modifying agents comprising silicon based surface modifying agents fluorinated alcohols, brominated low molecular oil.

These agents provide a smoother coating to the ink receptive layer.

In accordance with a preferred embodiment of this invention the emulsion of the ink receptive layer includes at least one surface active agent up to 0.01 percent of the total mass of the emulsion.

Typical surface active agents include non ionic polyalkylene oxides, polyethylene glycol derivatives, acetylene diols or anionic surface active agents such sodium do decyl benzene sulphate These surface active agents cause emulsification of the emulsion.

In accordance with a preferred embodiment of this invention the emulsion of the ink receptive layer includes water dispersible pigment particles.

Typically, the pigment particles are inorganic pigments such as alumina sol and cationic colloidal silica 0.1 to 3 microns in the range of 0.01 to 0.5 percent are used as additives.

The binder in the emulsion of ink receptive layer is at least one binder selected from a group of binders containing starch, carboxymethyl cellulose, cationized gelatin and cationized starch, acrylic latexes, SBR latexes and polyvinyl acetate latexes, polyurethane dispersions, hydroxy ethyl cellulose, epoxy ethyl cellulose and other water soluble dispersible derivatives of cellulose, methyl methacrylate, polymethyl methacrylate, styrene butyl acrylate, and co polymers of acrylic acid, ethylene vinyl acetate, or mixtures thereof.

In accordance with another preferred embodiment of the invention a surface-roughening agent such as a powder of silica, hard polymer bead, synthetic boehmite, precipitated calcium carbonate, bleached kaolin, aluminium oxide, having particle size 0.5 to 12 microns is added in the liquid coating emulsion of the ink receptive layer.

The mass of surface roughening agent range from 0.1 to 0.5 percent of the total mass of the emulsion of the ink receptive layer.

In accordance with a preferred embodiment of the invention the acrylic polymer is mixed with an acrylic copolymer containing a cationic co monomer along with the acrylic monomers selected from a group containing the following cationized pyrrolidine derivatives, tertiary amines, vinyl pyridine, and vinyl imidazole.

The emulsion of the ink receptive layer may preferably include at least one co solvent to allow the coalescence of the polymers while drying at high speed.

Typical co solvent is selected from a group containing the following co solvents: ethanol, isopropanol, octanol, butanol, hexanol, propylene glycol, propylene glycol mono methyl ether, ethylene glycol, mono ethyl ether, cellosolve acetate, and a mixture of one or more of the aforesaid co solvents.

The substrate is either made antistatic or is coated on one side with an antistatic coating or undergoes an antistatic treatment using methods known to the people in the art of manufacturing such polymer films The anti static agent used may be at least one agent selected from a group of agents comprising anionic sodium alkane sulphonate, cationic alkyl ammonium chloride, alkyl ammonium phosphate, alkyl ammonium methane sulphate, alkyl betains or mixtures of any two or more of these agents.

In accordance with a preferred embodiment of this invention the high-resolution high-density positive image producing film in accordance with this invention may further contain an anti halation layer below the ink receptive coating or below the anti static layer.

The anti halation layer is anti reflective to avoid halo around the image.

Preferably the anti halation layer is 0.1 to 0.5 micron in thickness containing anti halation dyes, particularly colloidal gold nano particles or colloidal silver nano particles.

In accordance with a preferred embodiment of this invention, the high-resolution high-density positive image producing film in accordance with this invention further contains a carrier layer provided on the inoperative surface of the substrate the said carrier layer adapted to enable the smooth transport of the film in the printing and processing machine. Typically the anti-static layer is the carrier layer.

The ink receptive layer mentioned in the film is coated using methods such as roll coating, rod coating, air knife coating, gravure coating or using slot coating

The dry coating weight of the ink receptive layer can be between 5 g per M² to 30 g per M² the corresponding thickness varying from 4 micron to 25 micron.

The properties of the product in this invention are represented in the following examples

### EXAMPLES

The embodiment of the invention is further explained by the following examples

### Example 1

4 gram of hydroxy-ethyl cellulose (medium molecular weight) is dissolved in 40 gram warm dematerialized water. This was then mixed with 20 gram of a 20% solution of 88% hydrolyzed PVA of molecular weight 4000 and 10 gram of a 40% aqueous solution of a cationic resin comprising di-methyl amino ethyl methacrylate as the cationic moiety. thoroughly and stirred with 20 gram The solution is mixed thoroughly and stirred with 20 grams of a 10% aqueous solution of synthetic Boehmite.

2 gram of vinyl acetate homo-polymer latex of 50% solid is then added over a period of 10 minutes with slow stirring.

3 milliliter of a 10% solution of fluorinated alcohol is added to the above emulsion as a surface modifying agent followed by 0.4 milliliter of a 10 percent aqueous solution of polyalkylene oxide as a surface active agent to assist uniform defect free coating.

A Biaxial oriented 100 micron polyester sheet of <2% haze is treated with corona discharge and is coated with a water dispersible polyester resin such as AQ 55 from Eastman chemicals using a 0.15 mm wire wound bar and dried at 100 degree C. for 2 min in an air oven, to get a coating of 5 mg per M^{2.} The film is then coated with the above emulsion using a 1.2 mm wire wound bar and dried in an air oven at 100 degree C. for 3 min. so that the coated film has a thickness of 120 micron

### Example 2

4 gram of hydroxy-ethyl cellulose (medium molecular weight) is dissolved in 40 gram warm dematerialized water. This was then mixed with 30 gram of a 20% solution of low molecular weight 5000 PVA 88% hydrolyzed. The solution is mixed thoroughly and stirred with 15 gram of 20% aqueous colloidal silica of 40 Nm. particle size.

The solution was coated on to clear polyester as in example 1

### Example 3

4 gram of medium molecular weight borated PVA is dissolved in 40 gram warm dematerialized water. This was then mixed with 30 gram of a 20% solution of 88% hydrolyzed PVA of low molecular weight. The solution is then mixed with 20 gram of an anionic aqueous dispersion of colloidal silica of 20% solids.

The solution was coated on to a 100-micron clear polyester film of <2% haze, pre-coated with a water dispersible polyester resin, using a 1.2 mm wire wound bar and dried at 100 degree Celsius for 2 minutes.

### Example 4

4 gram of 88% hydrolyzed PVA of low molecular weight is dissolved in 40 gram warm dematerialized water. This was then mixed with 30 gram of a 20% solution of 88% hydrolyzed PVA low molecular weight. The solution is then mixed with 10 gram of 10% solution of 99% hydrolyzed PVA and 5 gram of a 1% dispersion of precipitated silica in water.

The coating is carried out as in example 1.

### Example 5

The emulsion is prepared as in example 4, but the 88% PVA is replaced by 40 gram of 12.5% solution of a cationic polyvinyl alcohol of medium molecular weight. An additional quantity of 10 gram of 10% solution of synthetic Boehmite is added to the emulsion. The emulsion is coated and dried as in example 1

### Example 6

55 gram of a 12.5% solution of cationic polyvinyl alcohol is mixed with 15 gram of 20% of 88% hydrolyzed PVA of 4000 molecular weight. To this is added 10 gram of 10% solution of synthetic Boehmite and 5 gram of 1% precipitated silica. The coating and drying is carried out as in example 1.

### Example 7

The emulsion is prepared as in example 6 in which cationic PVA is replaced by an equal quantity of PVA 88% hydrolyzed of molecular weight 5000.

### Example 8-14

The films coated as in examples 1 to 7 were further corona treated on the backside and the backside is further coated, to get a coat of 3 grams/meter square, with the following preparation using a 0.5 mm wire wound bar and dried at 110 degree C. for 2 minutes

| | |
|---|---|
| Aqueous Polyurethane Dispersion | 35% |
| Silica pigment (10% solid) (12 micron) | 0.2% |
| Anionic sodium alkane sulphonate | 0.02% |
| Water | 62% |
| Isopropanol | 2.8% |

The coated films were then examined for various quality parameters such as film tackiness and film clarity.

The films were imaged on an Epson 1290 printer using dye-based ink (Epson cartridge number T 09 and other makes.)

The results are given in the table 1 below.

| | Properties: → | | | | | |
|---|---|---|---|---|---|---|
| | Drying | | | Image | Back- | |
| Exp | time | Tackiness | Bronzing | resolution | ground | UV |
| No: ↓ | (min) | (1-10)* | (1-10)* | (1-10)* | density | density |
| 1 | 6 | 3 | 8 | 8 | 0.2 | 1.65 |
| 2 | 4 | 6 | 9 | 9 | 0.03 | 2.1 |
| 3 | 2 | 8 | 8 | 8 | 0.03 | 2.35 |
| 4 | 3 | 9 | 6 | 9 | 0.02 | 2.1 |
| 5 | 3 | 9 | 8 | 9 | 0.02 | 2.4 |
| 6 | 3 | 9 | 8 | 9 | 0.03 | 2.5 |
| 7 | 3 | 9 | 8 | 9 | 0.02 | 2.6 |

*10 being best result

The printed samples were further subjected to humidity treatment at 40 degree Celsius and 75% humidity for 144 hrs.

The film property is mentioned in the table 2

| Examples→ | 1 | 2 | 3 | 4 | 5 | 6 | 7 |
|---|---|---|---|---|---|---|---|
| Image | 10 | 8 | 8 | 6 | 9 | 9 | 9 |
| quality | | | | | | | |
| (1-10) | | | | | | | |

### Example 15

On a corona treated polyester film of 125 microns with a bonding substratum of pre-coated polyester resin provided thereon an anti halation layer made my intimately mixing the following composition was applied by rod coating:

| | | |
|---|---|---|
| PVA 88% hydrolyzed of molecular weight 4000 | 80 | gms |
| Colloidal Gold dispersion [nano particles] | 0.01 | gm |
| Isopropyl alcohol | 8 | gms |
| De-mineralized water | 10 | gms |
| Silicone [Surface modifying agent] | 0.02 | gms. |

The coating was dried at 100 degrees Celsius for 30 minutes to get a coating of 0.5 micron

An emulsion was prepared by intimately mixing 55 gram of a 12.5% solution of cationic polyvinyl alcohol with 15 gram of 20% of 88% hydrolyzed PVA 4000 molecular weight. To this is added 10 gram of 10% solution of synthetic Boehmite and 5 gram of 1% precipitated silica and 0.01 gram of acetylene diol sodium laurel sulphate. This emulsion was applied over the anti halation layer in the manner as per example 6.

An anti static layer was provided on the uncoated surface using cationic alkyl ammonium chloride dispersed in a latex binder.

When tested in the above manner for image quality, the film shows a quality of a score of 10 with the additional property that the image was sharper and without even the slightest of halo.

The imaged samples were used as positive and exposed on to reproducible tracing film, positive working printing plate as well as an indirect stencil film. The films show exposing characteristics equivalent to silver based film processed through and image setter equipment, with respect to line definition and image density.

The product under the invention, therefore, is a clear film with an ink receiving layer on one side of the film. The ink receiving layer is such that it can receive ink jet ink from printers made using various ink jet technologies such as continuous ink jet printing, or drop on demand and in drop on demand it can be of thermal technology or of piezo technology.

The inks can be of pigment based or dye base though the current invention relates to ink receiving layer capable of optimum performance if used with a dye based ink from a piezo or thermal ink jet printers

Another important feature of the invention is the high optical density of the image. This high density enables the imaged film to be used as a positive for further exposing the image on to a light sensitive film, aluminum plate, a screen stencil film or a light sensitive polymer coated screen so as to create a photo image or to initiate photomechanical process. These photomechanical processes are there by used for creating printing masters for further printing by methods such as offset lithography, serigraphy, gravure or flexo printing

1. A high-resolution high-density positive image producing film using an ink jet printing machine which comprises:
(a) a substrate of at least one layer of an optically clear hydrophobic polymeric resin, said substrate having dimensional stability defined by two surfaces, said substrate being of thickness ranging from 50 to 200 microns, and defined by an operative image receiving surface; and a second inoperative backing surface;
(b) an ink-receptive coating layer provided on the said base coat said ink receptive coating layer of thickness ranging from 5 to 30 microns and having a dry weight between 5 g per sq. meter to 30 g per sq. meter and being formed by coating with a liquid coating emulsion comprising, as a uniform blend in an aqueous medium:
[i] water soluble hydrophilic polymer of medium molecular weight, mass of said water soluble hydrophilic polymer in the coating composition ranging from 5 to 20% of the total mass of the composition;
[ii] a cationic resin; mass of said cationic resin in the coating composition ranging from 3 to 8% of the total mass of the composition;
[iii] at least one binder; mass of said binder in the coating composition ranging from 2 to 10% of the total mass of the composition;
[iv] de-mineralized water, mass of said de-mineralized water mass in the coating composition ranging from 70 to 90% of the total mass of the composition;
(c) a bonding substratum coating of thickness ranging from 0.5 to 3 microns comprising a cross linkable water based polymeric resin provided between the ink-receptive coating layer and the substrate; and
(d) an anti static layer of thickness ranging from 3 to 8 microns provided on the inoperative surface of the substrate, said anti static layer comprising a solution of an anti static agent 0.01 to 1 percent, and a binder 10 to 20 percent dispersed in water.

2. A high-resolution high-density positive image producing film as claimed in claim 1, in which the resin used for making the substrate may be at least one resin selected from a group containing polyethylene terephthalate, poly propylene, polycarbonate, cellulose diacetate, cellulose triacetate, clear resins of other of cellulose derivatives such cellulose acetate butyrate, or cellulose acetyl phthalate, polyvinyledene fluoride, clear acrylic, nylon and its derivatives, and polyvinyl butyral or mixtures thereof.

3. A high-resolution high-density positive image producing film as claimed in claim 1, in which the substrate may be in the form of a single layer or may be multi layered, each layer having a single resin or a mixture of at least two resins.

4. A high-resolution high-density positive image producing film as claimed in claim 1, in which the substrate may be made anti-static.

5. A high-resolution high-density positive image producing film as claimed in claim 1, in which at least one of the surfaces of the substrate may be subjected to treatment to enhance the adhesion of water based coatings on the surface.

6. A high-resolution high-density positive image producing film as claimed in claim 1, in which the surface treatment is a treatment selected from a group if treatments containing corona treatment, etching with an acid, etching with an alkali, flame treatment, plasma treatment, and ion etching.

7. A high-resolution high-density positive image producing film as claimed in claim 1, in which the coating of the ink receptive film is water based emulsion.

8. A high-resolution high-density positive image producing film as claimed in claim 1, in which the water soluble hydrophilic polymer in the emulsion of the ink receptive layer is a polymer selected from a group of polymers containing polyvinyl alcohol, derivatives of polyvinyl alcohol such as acetoacetylated polyvinyl alcohol, borated polyvinyl alcohol, cationised polyvinyl alcohol, or a combination of these, poly acryl amide, acrylic acid co polymers, and polyamines.

9. A high-resolution high-density positive image producing film as claimed in claim 1, in which the hydrophilic polymer, typically the polyvinyl alcohol used can be partially hydrolyzed or fully hydrolyzed.

10. A high-resolution high-density positive image producing film as claimed in claim 1, in which the ink receptive layer includes an acrylic or vinyl polymer, mass of said acrylic polymer in the coating composition ranging from 2 to 10% of the total mass of the composition.

11. A high-resolution high-density positive image producing film as claimed in claim 1, in which the ink receptive layer includes at least one surface modifying agent up to 0.01 percent of the total mass of the emulsion.

12. A high-resolution high-density positive image producing film as claimed in claim 11, in which the at least one surface modifying agent is selected from a group of surface agents comprising silicon based surface modifying agents fluorinated alcohols, brominated low molecular oil.

13. A high-resolution high-density positive image producing film as claimed in claim 1, in which the ink receptive layer includes at least one surface active agent up to 0.01 percent of the total mass of the emulsion.

14. A high-resolution high-density positive image producing film as claimed in claim 1, in which the surface active agents include at least one agent selected from a group of agents consisting of non ionic such as polyalkylene oxides, polyethylene glycol derivatives, di acetate alcohols or ionic surface active agents such as soaps and sodium laurel sulphate

15. A high-resolution high-density positive image producing film as claimed in claim 1, in which the ink receptive layer includes water dispersible pigment particles.

16. A high-resolution high-density positive image producing film as claimed in claim 15, in which the pigment particles are inorganic pigments such as particles of alumina sol, cationic colloidal silica, or polymer particles such as micron-size polystyrene or polyamide fine particles, 0.1 to 3 microns in the range of 0.01 to 0.5 percent used as additives.

17. A high-resolution high-density positive image producing film as claimed in claim 1, in which the binder in the emulsion of ink receptive layer is at least one binder selected from a group of binders containing starch, carboxymethyl cellulose, cationized gelatin and cationized starch, acrylic latexes, SBR latexes and polyvinyl acetate latexes, polyurethane dispersions, hydroxy ethyl cellulose, epoxy ethyl cellulose and other water soluble dispersible derivatives of cellulose, methyl methacrylate, polymethyl methacrylate styrene butyl acrylate, and co polymers of acrylic acid, ethylene vinyl acetate, or mixtures thereof.

18. A high-resolution high-density positive image producing film as claimed in claim 1, in which a surface-roughening agent such as a powder of silica, hard polymer bead, synthetic boehmite, precipitated calcium carbonate, bleached kaolin, aluminium oxide, having particle size 0.5 to 12 microns is added in the liquid coating emulsion of the ink receptive layer.

19. A high-resolution high-density positive image producing film as claimed in claim 18, in which the mass of surface roughening agent range from 0.1 to 0.5 percent of the total mass of the emulsion of the ink receptive layer.

20. A high-resolution high-density positive image producing film as claimed in claim 10, in which the acrylic or vinyl polymer is mixed with an acrylic copolymer containing a cationic co monomer along with the acrylic monomers selected from a group containing the following: cationized pyrolidine derivatives, tertiary amines, vinyl pyridine, and vinyl imidazole.

21. A high-resolution high-density positive image producing film as claimed in claim 1, in which the ink receptive layer includes at least one co solvent to allow the coalescence of the polymers while drying at high speed.

22. A high-resolution high-density positive image producing film as claimed in claim 1, in which the co solvent is selected from a group containing the following co solvents: ethanol, isopropanol, octanol, butanol, hexanol, propylene glycol, propylene glycol monemethyl ether, ethylene glycol, mono ethyl ether, celosol acetate, and a mixture of one or more of the aforesaid co solvents.

23. A high-resolution high-density positive image producing film as claimed in claim 1, in which the anti static agent used may be at least one agent selected from a group of agents comprising anionic sodium alkane sulphonate cationic alkyl ammonium chloride, alkyl ammonium phosphate, alkyl ammonium methane sulphate, alkyl betains or mixtures of any two or more of these agents.

24. A high-resolution high-density positive image producing film as claimed in claim 1, in which the said film further contains an antihalation layer below the ink receptive coating or below the anti static layer.

25. A high-resolution high-density positive image producing film as claimed in claim 1, in which the ant-halation layer is 0.1 to 0.5 micron in thickness containing anti halation dyes, particularly colloidal gold nano particles or colloidal silver nano particles.

26. A high-resolution high-density positive image producing film as claimed in claim 1, in which the ink receptive layer is coated using methods such as roll coating, rod coating, air knife coating, gravure coating or using slot coating.
